(19) United States
(12) Patent Application Publication
(10) Pub. No.: US 2024/0411488 A1
(43) Pub. Date: Dec. 12, 2024

(54) CARD PRINTER CONSUMABLE SUPPLIES

(71) Applicant: Entrust Corporation, Shakopee, MN (US)

(72) Inventors: Patrick CRONIN, Shakopee, MN (US); Andrew DePOMPOLO, Shakopee, MN (US); Justin EAYRS, Shakopee, MN (US)

(21) Appl. No.: 18/740,018

(22) Filed: Jun. 11, 2024

Related U.S. Application Data
(60) Provisional application No. 63/507,670, filed on Jun. 12, 2023.

(51) Int. Cl. G06F 3/12; B41J 2/175; B41J 3/407

(52) U.S. Cl. CPC G06F 3/1203; B41J 2/17546; B41J 3/407; G06F 3/1235

(57) ABSTRACT

A technique is described to enable software access to a card printer to control card printing. A consumable supply that is installed in the card printer is authenticated, for example locally by the card printer or remotely by a remote card printer controller. Once the consumable supply is authenticated, validation data that results from electronically reading data that is stored on the consumable supply is validated. If the validation data is validated, software access to the card printer to control card printing is enabled. The validation data may be validated locally within the card printer or remotely by the remote card printer controller. Authentication of the consumable supply can also automatically cause a temporary change of a default printer parameter to a second, temporary printer parameter, and when the card printer detects a consumable supply event the default printer parameter can be automatically restored.

### FIELD

This technical disclosure relates to processing personalized identification documents such as personalized cards, and printing on such documents using one or more consumable supplies.

### BACKGROUND

Identification documents such as identification cards, credit and debit cards, driver's licenses, and the like, and passports are personalized with information concerning the intended holder of the identification document and then issued to the intended holder. The personalization often takes places in printers that are typically referred to in the card printing industry as card printers.

### SUMMARY

Systems and methods for controlling a card printer by enabling and disabling software access to the card printer to control card printing are described. A consumable supply that is installed in the card printer is authenticated, for example locally by the card printer or remotely by a remote card printer controller. Once the consumable supply is authenticated, validation data that results from electronically reading data that is stored on the consumable supply is validated. If the validation data is validated, software access to the card printer to control card printing is enabled. The software access can be remote, for example via cloud-based software that is part of the remote card printer controller, or local, for example software residing in the card printer. The validation data may be validated locally within the card printer or remotely by the remote card printer controller. Authentication of the consumable supply can also automatically cause a temporary change of a default printer parameter to a second, temporary printer parameter, and when the card printer detects a consumable supply event the default printer parameter can be automatically restored.

In an embodiment, the authentication of the consumable supply can occur within the card printer, and the validation of the validation data can occur in the remote card printer controller. Upon validation, the remote card printer controller is able to control the card printer to conduct card print jobs. In another embodiment, the authentication of the consumable supply and validation of the validation data can occur in the card printer. In still another embodiment, the authentication of the consumable supply and validation of the validation data can occur in the remote card printer controller.

The consumable supply includes data stored in a data storage. The data storage can be any type of data storage that is suitable for storing data that can be electronically read by an electronic reader. The electronic reading of the data can be contactless or require contact. For example, the data storage can comprise a radio frequency identification (RFID) tag, an integrated circuit chip, a bar code, or any other type of electronically readable data storage device. Each data storage device can have a unique identifier associated therewith that uniquely identifies the data storage device, and therefore uniquely identifies the consumable supply having that data storage device.

The change in the default printer parameter to the second, temporary printer parameter can occur automatically upon authentication of the consumable supply. In addition, detection of a consumable supply event can cause the default printer parameter to be automatically restored. In an embodiment, restoring the default printer parameter can also disable the software access to the card printer to prevent further print jobs under command of the software.

In an embodiment, the default printer parameter can be “software disabled” whereby the remote card printer controller is not able to control the card printer, and the second, temporary printer parameter can be “software enabled” that enables the card printer to be controlled by the remote card printer controller. When “software disabled”, the card printer may or may not be able to communicate with the remote card printer controller. If the card printer is not able to communicate with the remote card printer controller, the card printer may still be able to use the internet or otherwise communicate externally of the card printer with other devices, although the remote card printer controller is not able to control the card printer. The default printer parameter can be other parameters of the card printer, such as parameters that are not directly associated with the consumable supply. In an embodiment, the default printer parameter can be a non-supply parameter of the card printer.

A card printer control method includes receiving, at a remote card printer controller separate from a card printer, validation data from the card printer. For example, the validation data can result from electronically reading data stored on a consumable supply that is usable with the card printer. The data can be automatically read once the consumable supply is installed into the card printer or prior to installing the consumable supply. The received validation data is processed to determine if the validation data is valid. If the validation data is determined to be valid, the remote card printer controller is permitted to control operation of the card printer to print a card, which can include sending at least one print command to the card printer. Alternatively, validation of the validation data can occur locally within the card printer, for example in local software residing in the card printer.

The remote card printer controller is permitted to control operation of the card printer as long as a consumable supply event has not been detected. If a consumable supply event is detected, such as the consumable supply is removed from the card printer, is spent, has reached a predetermined date, or has been used a predetermined number of times, control of the card printer by the remote card printer controller is terminated until a new consumable supply is authenticated and validation data is validated.

A card printer control system includes a remote card printer controller separate from a card printer. The remote card printer controller is configured to receive validation data from the card printer that results from electronically reading data stored on a consumable supply that is useable in the card printer. The data can be read upon installing the consumable supply into the card printer or prior to installing the consumable supply into the card printer. The remote card printer controller is configured to process the received validation data to determine if the validation data is valid. If the validation data is determined to be valid, thereafter the remote card printer controller is able to control the card printer, for example by sending at least one print command to the card printer to print a card.

A card printing system includes a card printer having a card input, a card output, a print station, a local card printer controller that controls operation of the card printer, and an electronic reader that is capable of electronically reading data stored on a consumable supply. The card printer has at least one default printer parameter that may be controllable and automatically changed, for example by the card printer and the local card printer controller thereof. A consumable supply is installable in the card printer, and the consumable supply includes a data storage device with data stored thereon that is readable by the electronic reader. The card printer is configured to read data from the data storage device and authenticate the consumable supply, and if the consumable supply is determined to be authentic automatically temporarily change the at least one default printer parameter to a second, temporary printer parameter, and when the card printer detects a consumable supply event automatically restore the at least one default printer parameter.

In another embodiment, a card printing system can include a card printer having a card input, a card output, a print station, a local card printer controller that controls operation of the card printer, and an electronic reader that is capable of electronically reading data stored on a consumable supply. The card printer has at least one default printer parameter that is controllable by the local card printer controller. A consumable supply is installable in the card printer and the supply includes a data storage device with data stored thereon that is readable by the electronic reader. The card printer is configured to automatically temporarily change the at least one default printer parameter to a second, temporary printer parameter upon installation of the consumable supply in the card printer, and to restore the at least one default printer parameter upon detection of a consumable supply event.

Different consumable supplies can be provided each having a different data storage device having different stored data. The consumable supplies can be the same type of consumable supplies, for example all multi-color print ribbons, or different types of consumable supplies. The data storage devices can have different data that change different default printer parameters of the card printer.

### DRAWINGS

FIG. 1 schematically illustrates an example of a card printer control system described herein.

FIG. 2 schematically illustrates example components of the card printer of the system.

FIG. 3 schematically illustrates example components of the remote card printer controller of the system.

FIG. 4 schematically illustrates example components of the user interface device of the system.

FIG. 5 illustrates an example of a method of temporarily changing a default printer parameter.

FIG. 6 illustrates an example of a method of validating the validation data from the card printer.

FIG. 7 illustrates an example of a method of generating a print command.

FIG. 8 illustrates an example of a plastic card.

FIG. 9 illustrates an example of a consumable supply with an RFID tag.

FIG. 10 illustrates different consumable supplies having different RFID tags.

FIG. 11 schematically depicts an example arrangement of components of an identification document processing system that can be controlled as described herein.

FIG. 12 illustrates another embodiment of a method that includes local authentication of the consumable supply, local validation of the validation data, and local software control of card printing.

### DETAILED DESCRIPTION

The following is a description of systems and methods for controlling a card printer by enabling and disabling software access to the card printer to control card printing. A consumable supply that is installed in the card printer is authenticated. Once the consumable supply is authenticated, validation data that results from electronically reading data that is stored on the consumable supply is validated. If the validation data is validated, software access to the card printer to control card printing is enabled. Authentication of the consumable supply can also automatically cause a temporary change of a default printer parameter to a second, temporary printer parameter, and when the card printer detects a consumable supply event the default printer parameter can be automatically restored. In one specific example, cloud-based control of the card printer is described. The card printing process is controlled remotely from the card printer (for example, by cloud-based printing software), with authentication of the consumable supply occurring in the card printer, and validation of the validation data occurring in a remote card printer controller. In another example, the card printing process is controlled locally within the card printer, with authentication of the consumable supply occurring in the card printer and validation of the validation data occurring in the card printer. Authentication of the consumable supply also causes a change to at least one default parameter of the card printer to a second, temporary default parameter. The software access and control of the card printer is permitted until a consumable supply event is detected at which time software access to the card printer is disabled.

The term “card” used herein refers exclusively to personalized identification documents such as financial cards (e.g. credit and debit cards), driver's licenses, national identification cards, and the like, that are personalized with information concerning the intended holder of the identification document and then issued to the intended holder. In an embodiment, the identification cards may be ID-1 cards as defined by ISO/IEC 7810 with dimensions of about 85.60 by about 53.98 millimeters (about 3 ⅜ in×about 2 ⅛ in) and rounded corners with a radius of about 2.88-3.48 mm (about ⅛ in). However, other card formats such as ID-2 as defined by ISO/IEC 7810 are possible as well. The card may be referred to as a “plastic card” which refers to a card where the card substrate can be formed entirely of plastic, or formed of a combination of plastic and non-plastic material. Examples of plastic materials that the card or passport pages, or the individual layers of the card or passport can be formed from include, but are not limited to, polycarbonate, polyvinyl chloride (PVC), polyester, acrylonitrile butadiene styrene (ABS), polyethylene terephthalate glycol (PETG), TESLIN®, combinations thereof, and other plastics. The card may also be partially or entirely formed of biodegradable materials, such as layers of paper, whereby the card may be partially biodegradable or entirely biodegradable. A card excludes a single sheet of paper that is printed on with personal information, and a paper card is not a single sheet of paper.

A “card printer” refers to the type of printers that are configured to print on and otherwise personalize the types of cards in the preceding paragraph. A card printer excludes a paper printer and a photocopier that prints on individual sheets of paper.

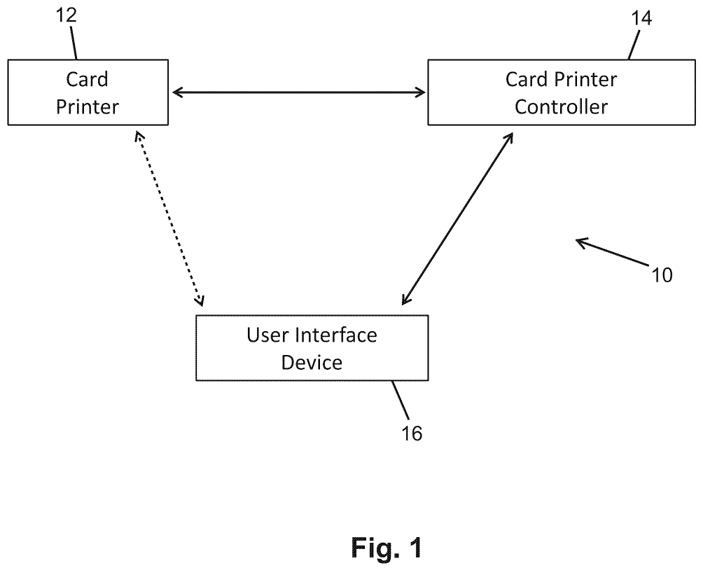

Referring now to FIG. 1, a card printer control system 10 is illustrated. The system 10 is depicted as including a card printer 12, a remote card printer controller 14, and a user interface device 16. The card printer 12 and the remote card printer controller 14 can be in two-way communication, for example via the internet. The remote card printer controller 14 and the user interface device 16 can also be in two-way communication, for example via the internet. In one embodiment, the card printer 12 and the user interface device 16 are not in communication with one another. However, in another embodiment, the card printer 12 and the user interface device 16 may be in one-way or two-way communication with one another, for example via the internet or via Bluetooth® or other communication technology, as indicated by the broken line. In an embodiment, the card printer controller 14 and the user interface device 16 can be integrated together into a single, unitary device.

The card printer 12 is configured to be able to perform a print job on a card by inputting a card, printing on the card, optionally performing other processing operations on the card, and outputting the personalized or individualized card. The remote card printer controller 14 is configured, in one embodiment, to control the printing operation of the card printer 12 by generating a print command that is sent to the card printer 12. Alternatively, printing by the card printer 12 can be controlled by a local printer controller of the card printer 12. The print command dictates the data to be printed on card, as well as the format or arrangement of the data on the card. The print command may also dictate and control other application(s) of data to the card such as control programming of a programmable chip on the card or encoding of data onto a magnetic strip on the card. The user interface device 16 acts as a means by which a user can enter data to be printed on the card and generate a print request that is sent to the remote card printer controller 14.

In one embodiment, the card printer 12 authenticates a consumable supply that is installed in the card printer 12, and also sends validation data to the remote card printer controller 14 to be validated by the remote card printer controller 14. The validation data may be obtained from or based on data stored on the consumable supply that is electronically read by the card printer 12. The data can be stored on the consumable supply, for example on any suitable data storage device. Examples of data storage devices that can be used include an RFID tag, an integrated circuit, and/or a bar code on the consumable supply. The data on the data storage device can be electronically read, contactlessly or requiring contact, upon installation of the consumable supply into the card printer 12 or prior to installing the consumable supply into the card printer. The initial programming of the data on the data storage device of the consumable supply can occur at the factory, by a distributor that distributes the consumable supply, by an end user of the consumable supply, or at any other time in the supply chain of the consumable supply. The initial programming of the data, and any subsequent programming, of the data storage device may also occur remotely, for example as described in US 2021/0146694 the entire contents of which are incorporated herein by reference.

The card printer 12 reads the data from the data storage device on the consumable supply and uses the data to authenticate the data storage device and hence the consumable supply. In an embodiment, authentication of the consumable supply can occur as follows. For simplicity, this example assumes that the data storage device is an RFID tag. However, the data storage device can be other devices. Multiple fields programmed on the RFID tag are hashed and then digitally signed by a private key. The private key may be stored in a hardware security module (HSM) or other secure storage location. That signature is then written onto the RFID tag. When the RFID tag is read by the card printer 12, for example when the consumable supply is installed into the card printer 12, the card printer 12 will read the same fields used to generate the original, stored hash and the card printer 12 will generate a hash. The card printer, which includes a public key corresponding to the private key, will then decrypt the digital signature programmed on the RFID tag and compare the stored hash to the hash that it just calculated. If they match, the consumable supply is considered to be authenticated.

The card printer 12 can also read additional data from the data storage device of the consumable supply that is unrelated to authentication. The reading of additional data can occur with the initial data reading to generate the hash, after the initial data reading, or after authenticating the consumable supply. The additional data can include a unique identifier of the consumable supply, a unique identifier of the card printer 12, operating parameters and set-up of the card printer 12, card processing capabilities of the card printer 12 including what specific card processing components are present in the card printer 12, what type of cards are loaded in the card printer 12, and other information.

If the consumable supply is authenticated, the card printer 12 then sends validation data to the remote card printer controller 14. Communications from the card printer 12 to the controller 14 may be encrypted. The remote card printer controller 14 receives the validation data and validates the validation data. Validation of the validation data can entail, but is not limited to, determining: that the consumable supply is appropriate for use in the card printer 12; is the card printer 12 an appropriate printer to be used; that the consumable supply is authorized for use in additional print jobs; and other validation scenarios. The validation data that is sent by the card printer 12 can include, but is not limited to, one or more of the following data: a unique identifier of the consumable supply, a unique identifier of the card printer 12, operating parameters and set-up of the card printer 12, card processing capabilities of the card printer 12 including what specific card processing components are present in the card printer 12, what type of cards are loaded in the card printer 12, and other data.

If the consumable supply is not authenticated by the card printer and/or the remote card printer controller 14 does not validate the validation data, the remote card printer controller 14 is not enabled to control the card printer 12 to perform print jobs. If the consumable supply is authenticated and the validation data is validated by the remote card printer controller 14, the remote card printer controller 14 is enabled to control the card printer 12 to perform print jobs. This control by the remote card printer controller 14 is enabled until a consumable supply event is detected. Examples of consumable supply events that can be detected include, but are not limited to, the consumable supply is removed from the card printer, the consumable supply is spent, a predetermined date such as an expiration date of the consumable supply has been reached, or a predetermined number of print jobs using the consumable supply are performed. Alternatively, authentication and validation may be required prior to each print job, or after a certain number of print jobs are performed, or after a certain period of time has elapsed.

The authentication of the consumable supply by the card printer 12 is also used to automatically temporarily change at least one default printer parameter of the card printer 12 to a second, temporary printer parameter. The default printer parameter can be any parameter relating to operation of the card printer 12. For example, the at least one default printer parameter can comprise “software disabled” where the card printer 12 may or may not be in communication with the remote card printer controller 14, but the remote card printer controller 14 is not able to control the card printer 12 to perform a print job and the second, temporary printer parameter can comprise “software enabled” where the card printer 12 is in communication with the remote card printer controller 14, for example via the internet, and is able to control the card printer 12 to perform a card print job. Other examples of default printer operation settings that can be controlled include, but are not limited to: the type of card to input for printing (for example in the case of a multi-hopper configuration); the transport speed of the card within the card printer 12 to control card throughput; the transport speed of the card during one or more specific card processing operations such as plasma treatment, to control card throughput and/or to control printing resolution; a cure delay time in the case of printing radiation curable materials; cure/no cure of a radiation curing station; laminate/no laminate of a lamination station; laser mark/no laser mark of a laser marking station; which light emitting diode or other radiating emitting element to use for curing radiation curable material in the radiation curing station; pin/no pin (i.e. partial cure or no partial cure); which output to use to output the printed card; chip program/no chip program by a chip programming station; magnetic strip encode/no magnetic strip encode by a magnetic strip encoding station; standard vs. non-standard magnetic strip encoding by the magnetic strip encoding station; flip the card/no flip of a card flipper; enable/disable specific hardware components of the card printer; and others. In an embodiment, the default printing parameter can be a non-supply parameter that is not directly related to or associated with the consumable supply such as the amount or type of supply that is installed. A specific example of a non-supply parameter includes, but is not limited to, a communication capability of the card printer such as preventing the card printer from communicating with and/or utilizing the remote card printer controller 14. Other examples of non-supply parameters include, but are not limited to: enable/disable specific hardware components of the card printer, such as enable/disable a chip programmer or a magnetic strip encoder or a laminator or a laser; whether to flip the card/no flip during duplex printing/no duplex printing; whether to perform custom magnetic strip encoding or standard magnetic strip encoding; whether to operate the card printer in a quiet mode or a standard mode; temporarily change the transport speed of the card within the card printer 12 to adjust card throughput; temporarily change the transport speed of the card during one or more specific card processing operations such as plasma treatment or during printing, to control card throughput and/or to control printing resolution; control the type of card that is input for a print job; temporarily change the print resolution of the print mechanism in the print station; and others.

Once the original default printer parameter of the card printer 12 is changed to the second, temporary printer parameter, the second, temporary printer parameter can remain until an event, referred to as a consumable supply event, occurs that causes the card printer 12 to automatically revert back to the original default printer parameter. For example, the card printer 12 can revert back to the original default printer parameter if a consumable supply event is detected, such as the consumable supply is removed from the card printer 12, the consumable supply is spent, a predetermined date such as an expiration date of the consumable supply has been reached, or the consumable supply has been used a predetermined number of times.

The consumable supply may be any consumable supply that is usable in the card printer 12. Examples of consumable supplies include, but are not limited to, thermal print ribbons (monochromatic and multi-color), drop-on-demand (DOD) inks and other DOD materials (radiation curable and non-radiation curable), laminate ribbons containing laminates to be applied to the cards, topcoat ribbons that apply topcoats to the cards, retransfer ribbons used in retransfer printing, topping ribbons that apply a colorant to embossed characters, indent ribbons that apply a colorant to indented characters, and others.

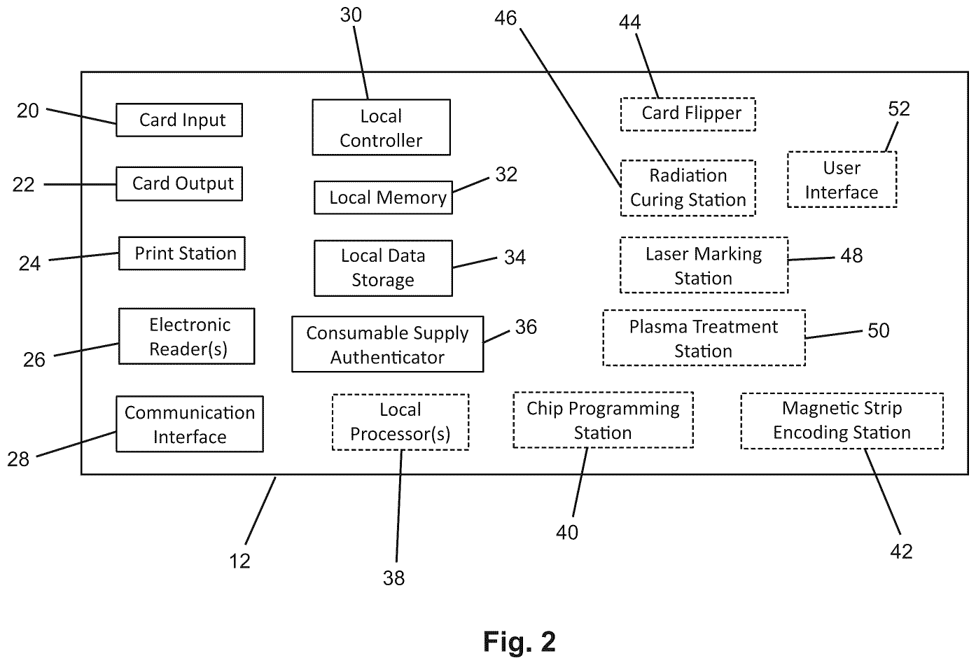

Referring to FIG. 2, an example of the card printer 12 is illustrated. The card printer 12 includes a card input 20, a card output 22, a print station 24, an electronic reader 26, a communication interface 28, a local controller 30, local memory 32, local data storage 34, a consumable supply authenticator 36, and local processor(s) 38. Optionally, the card printer 12 may also include one or more of a chip programming station 40, a magnetic strip encoding station 42, a card flipper 44, a radiation curing station 46, a laser marking station 48, a plasma treatment station 50, and a user interface 52.

The card input 20 can be a simple input slot through which an individual card is input, for example manually, into the card printer 12. Alternatively, the card input 20 can be a hopper that is designed to hold a plurality of cards waiting to be printed and which are automatically fed individually from the hopper for printing. The hopper may hold a single type of card, for example all the cards are from one bank or from one card issuer (e.g. Visa®, Mastercard®, etc.). Alternatively, the hopper can be configured as a multi-hopper configuration with different input hoppers holding different types of cards and any one of the cards from any one of the hoppers is able to be automatically fed depending upon and dictated by the print job. An example of a multi-hopper card feeder is disclosed in U.S. Pat. No. 10,699,509 the entire contents of which are incorporated herein by reference.

The card output 22 can be a simple output slot through which a personalized card is output from the card printer 12. Alternatively, the card output 22 can be a hopper or hoppers that is designed to hold a plurality of personalized cards after printing. The hopper may hold a single type of card, for example all the cards are from one bank or from one card issuer (e.g. Visa®, Mastercard®, etc.). Alternatively, the hopper can be configured as a multi-hopper configuration with different output hoppers holding different types of personalized cards and personalized cards can be directed into the correct output hopper based on the specific type of personalized card.

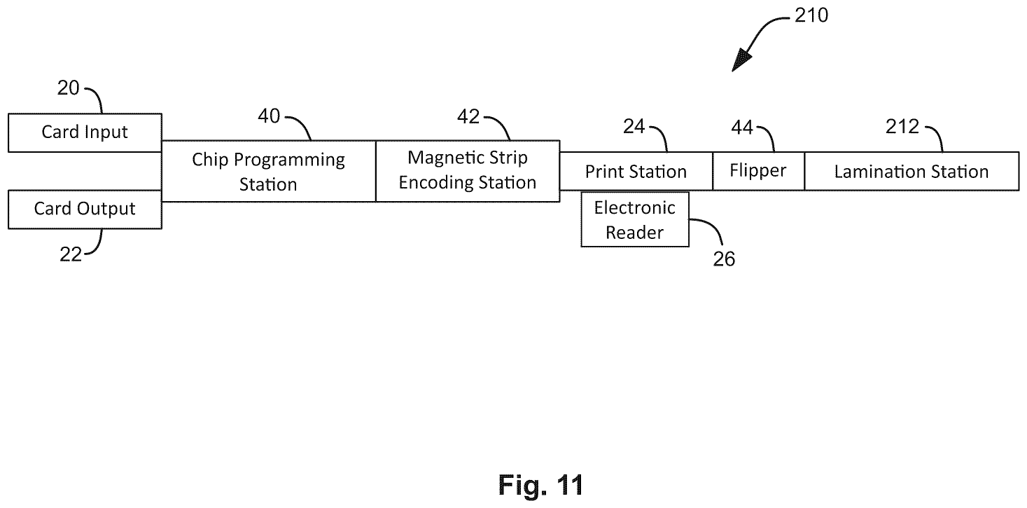

The input 20 and the output 22 may be located at the same end, such as a front end, of the card printer 12 (see FIG. 11), at opposite ends of the card printer 12 (not shown), one at the top/bottom of the card printer 12 and the other at a front end or a rear end of the card printer 12, or have any other relative locations in the card printer 12.

The print station 24 is configured to perform printing on a surface of a card using any suitable technique known in the art of card printing. Examples of the print station 24 include a direct-to-card thermal print station, a retransfer print station that performs retransfer printing, and a DOD print station. An example of a direct-to-card thermal print station is disclosed in U.S. Pat. No. 11,613,132 the entire contents of which are incorporated herein by reference. An example of a retransfer print station is disclosed in U.S. Pat. No. 9,904,876 the entire contents of which are incorporated herein by reference. An example of a DOD print station is disclosed in U.S. Pat. No. 10,049,320 the entire contents of which are incorporated herein by reference.

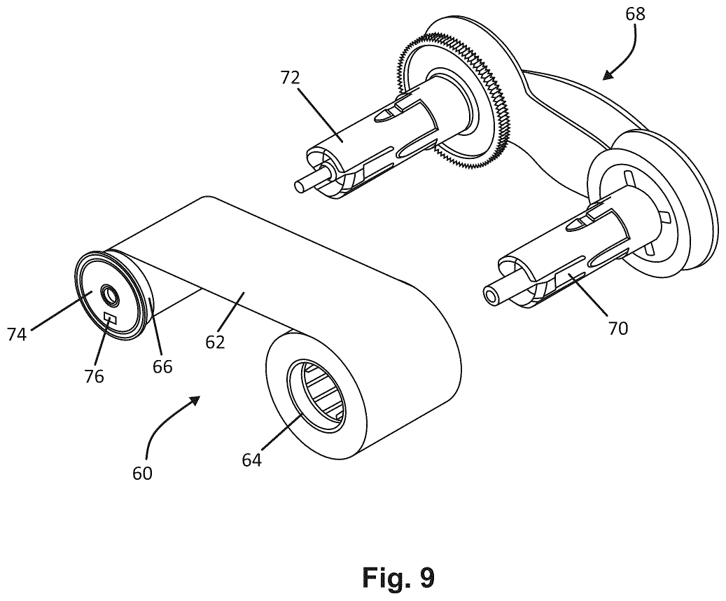

The printing by the print station involves use of at least one consumable supply. For example, with reference to FIG. 9, an example of a consumable supply 60 in the form of a thermal print ribbon is illustrated. However, the consumable supply 60 can be a retransfer ribbon, a supply of DOD material, or any other consumable supply. In the example illustrated in FIG. 9, the consumable supply 60 includes a print ribbon 62, which can be a monochromatic or multi-color print ribbon, that supplies the dye or ink used in the printing process. The print ribbon 62 is wound onto a supply core or cylinder 64 that is cylindrical in shape. The ribbon 62 includes a take-up end that is attached to a take-up core or cylinder 66 that is cylindrical in shape and upon which used ribbon is wound. The consumable supply 60 maybe considered to be just the ribbon 62 and the supply core 64, or the ribbon 62, the supply core 64 and the take-up core 66 in combination. In FIG. 9, the ribbon 62 is illustrated as being unused, with substantially the entire extent thereof wound onto the supply core 64, and the end of the ribbon 62 being attached to the take-up core 66 ready to take-up used ribbon. In an embodiment, both the supply core 64 and the take-up core 66 may be manually installed by a user into the card printer 12. Alternatively, as depicted in FIG. 9, the supply core 64 and the take-up core 66 are intended to be manually installed on a supply spindle 70 and a take-up spindle 72, respectively, on a cartridge 68 that is manually installed in the card printer 12. A cap 74 is attached to the end of either the supply core 64 or the take-up core 66, and a data storage device 76 in the form of an RFID tag is fixed to the cap 74. Further information on a consumable supply with an RFID tag is disclosed in U.S. Pat. No. 6,963,351 the entire contents of which are incorporated herein by reference. The data storage device 76 can have other configurations as described herein such as an integrated circuit or a bar code.

Returning to FIG. 2, the electronic reader(s) 26 is positioned in the card printer 12 at a location suitable to read the data storage device on the consumable supply. For example, when the consumable supply is used in the print station 24, the reader 26 can be positioned in or adjacent to the print station 24. For example, in the case of the consumable supply 60 in FIG. 9, the reader 26 can be positioned to be located adjacent to the end of whichever core (i.e. the supply core 64 or the take-up core 66) contains the data storage device 76. Further information on an electronic reader in the form of an RFID tag reader is disclosed in U.S. Pat. No. 6,963,351. The electronic reader 26 and the data storage device 76 may be configured for contact reading of the data (i.e. the electronic reader 26 physically contacts the data storage device 76 during data reading, for example in the case where the data storage device is an integrated circuit that requires physical contact) or non-contact reading of the data (i.e. the electronic reader 26 does not physically contact the data storage device 76 during data reading, for example in the case of an RFID tag or a bar code).

The communication interface 28 can be any type of communication interface that can permit the card printer 12 to communicate externally of the card printer 12, for example with the remote card printer controller 14. The communication interface 28 can be configured to permit communications via the internet. The communication interface 28 can be associated with the original default printer parameter of the card printer 12 where the communication interface 28 is disabled whereby the card printer 12 is not able or permitted to communicate via the internet with the remote card printer controller 14 although the card printer 12 may still be able to communicate with other external devices, and associated with the second, temporary printer parameter where the communication interface 28 is enabled which permits the card printer 12 to communicate via the internet with the remote card printer controller 14. The enabled/disabled state of the communication interface 28 can be controlled by the local controller 30.

The local controller 30 controls operation of the card printer 12 such as controlling card input and card output, controlling operation of the print station 24, controlling operation of the RFID tag reader(s) 26, controlling operation of the communication interface 28, controlling card transport mechanism(s) such as rollers and/or belts within the card printer 12 that transport the card, and controlling the operation of other mechanical components that may be present in the card printer 12. The local controller 30 may include, or be separate from, the local memory 32, the local data storage 34 and the one or more local processors 38 (such as one or more microprocessors, one or more GPUs and/or one or more CPUs). The local controller 30 may also perform the consumable supply authentication described herein.

The consumable supply authenticator 36 is configured to perform the authentication of the consumable supply as described above. The authenticator 36 may be part of the local controller 30 or separate from the local controller 30. The authenticator 36 may have its own resources (e.g. programming; processor(s)) for performing the authentication or may utilize the local memory 32 and local processor(s) 38.

Optionally, the card printer 12 may include the chip programming station 40 (also referred to as a smart card programming mechanism). If present, the chip programming station 40 may be the first mechanism downstream of the card input 20 and located between the card input 20 and the print station 24. The chip programming station 40 is configured to program a chip, contactlessly or via contact, embedded in each card. The chip programming station 40 can be configured to program one card at a time. Alternatively, the chip programming station 40 can be configured to simultaneously program multiple cards. The construction and operation of chip programming stations in general are well known. Examples of chip programming stations that simultaneously program multiple cards that could be utilized are described in U.S. Pat. No. 6,695,205 (disclosing an elevator-type chip programming mechanism) and U.S. Pat. No. 5,943,238 (disclosing a barrel-type chip programming mechanism), the entire contents of each patent are incorporated herein by reference.

Optionally, the card printer 12 may include the magnetic strip encoding station 42. If present, the station 42 may be downstream of the card input 20, for example located between the card input 20 and the print station 24. The station 42 is configured to magnetically encode data on a magnetic strip on the card. The construction and operation of magnetic strip encoding stations in general are well known in the art. In an embodiment, the functionalities of the chip programming station 40 and the station 42 can be combined into a single mechanism that can perform both chip programming and magnetic strip encoding.

Optionally, the card printer 12 may include a card flipper 44. If present, the card flipper 44 may be located downstream of the print station 24. The card flipper 44 is designed to flip the card 180 degrees, which is useful for duplex (i.e. two-sided) printing on the card. Examples of card flippers are disclosed in U.S. Published Application No. 2013/0220984 and U.S. Pat. No. 7,398,972 the entire contents of each are incorporated herein by reference.

Optionally, the card printer 12 may include the radiation curing station 46 and the plasma treatment station 50. If present, the radiation curing station 46 may be located downstream of the print station 24 while the plasma treatment station 50 is located upstream of the print station 24. The radiation curing station 46 is configured to generate and apply radiation to the card to cure radiation curable material applied to the card. The radiation may be ultraviolet (UV) radiation, for example from one or more light emitting diodes. The plasma treatment station 50 is configured to treat some or all of the surface of the card prior to applying radiation curable material to the card in order to make the card surface more receptive to the printing. An example of a mechanism that can generate and apply curing radiation in a card personalization system is the radiation applicator used in the DATACARD® MX8100™ Card Issuance System available from Entrust Corporation of Shakopee, Minnesota. An example of a plasma treatment mechanism is described in U.S. Pat. No. 10,576,769 the entire contents of which are incorporated herein by reference.

Optionally, the card printer 12 may include the laser marking station 48. If present, the laser marking station 48 may be located downstream of the print station 24. The laser marking station 48 includes a laser mechanism that generates a laser beam which is used to laser mark the card, for example by causing a darkening of the card material, and/or to texture the card surface. An example of a suitable laser that can be used can be found in the MX6100 Card Personalization System available from Entrust Corporation of Shakopee, Minnesota.

Optionally, the card printer 12 may include the user interface 52. If present, the user interface 52 is located on the card printer 12 to be accessible to the user. The user interface 52 may comprise one or more of a display screen which displays information to the user and/or one or more input devices such as buttons that allow a user to enter information. In an embodiment, the user interface 52 may be a touchscreen which both displays information and allows the user to enter information.

The card printer 12 can be arranged as or incorporated into a desktop card processing system that is typically designed for relatively smaller scale, individual card personalization in relatively small volumes, for example measured in tens or low hundreds per hour, often times with a single card being processed at any one time. These card processing machines are often termed desktop processing machines because they have a relatively small footprint intended to permit the processing machine to reside on a desktop. Many examples of desktop processing machines are known, such as the SIGMA™ and ARTISTA® family of desktop card printers available from Entrust Corporation of Shakopee, Minnesota. Other examples of desktop processing machines are disclosed in U.S. Pat. Nos. 7,434,728 and 7,398,972, each of which is incorporated herein by reference in its entirety.

FIG. 11 illustrates the card printer 12 with an example arrangement of some of the components in FIG. 2 into the form of a desktop card printer 210. Elements in FIG. 11 that are similar to elements in FIG. 2 are referenced using the same reference numerals. In FIG. 11, the desktop card printer 210 is configured with the card input 20 (input slot or hopper), the card output 22 at the same end that is configured to hold a plurality of processed cards or is just an output slot, the optional chip programming station 40 that programs an embedded integrated circuit chip in the card, the optional magnetic strip encoding station 42 that encodes a magnetic strip on the card, the print station 24, the electronic reader 26, and the optional card flipper 44. An optional lamination station 212 is also depicted that applies a protective laminate to the card overlaying the printing. The consumable supply described herein can be used in, for example, the print station 24 and/or in the lamination station 212 (in which case the lamination station 212 can also include an electronic reader). Other arrangements of desktop card printers are known and are possible. Further information on the construction and operation of one example of a desktop card printer is disclosed in U.S. Pat. No. 9,904,876 the entire contents of which are incorporated herein by reference.

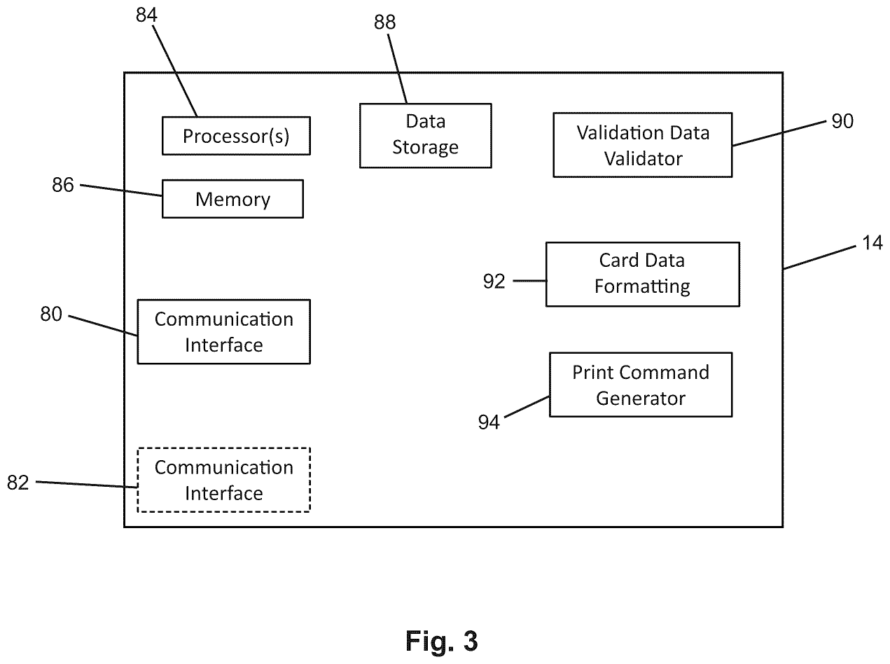

Referring to FIG. 3, an example of the remote card printer controller 14 is illustrated. The remote card printer controller 14 is depicted as including a communication interface 80, an optional additional communication interface 82, a processor(s) 84, memory 86, data storage 88, a validation data validator 90, a card data formatter 92, and a print command generator 94. Although FIG. 3 depicts the various elements as being integrated into a single location, some or all of the elements may be located in separate locations from the others.

The communication interface 80 can be any type of communication interface that can permit the remote card printer controller 14 to communicate with the card printer 12 and optionally with the user interface device 16. The communication interface 80 can be configured to permit communications via the internet. The optional additional communication interface 82 may be provided to allow the remote card printer controller 14 to communicate with the user interface device 16. Communications to and from the controller 14 may be encrypted.

The processor(s) 84 may be one or more microprocessors, one or more GPUs and/or one or more CPUs that execute program instructions stored in the memory 86 for performing the functions of the controller 14. The data storage 88 may store data received from the card printer 12 and store data received from the user interface device 16.

The validation data validator 90 is configured to receive some or all of the validation data from the card printer 12, and process the validation data to determine if the validation data is valid. For example, the validator 90 can process the validation data to, for example: determine that the consumable supply is appropriate for use in the card printer 12; that the card printer 12 is an appropriate printer to perform a desired print job; that the consumable supply has not reached an expiration date or other predetermined date; that the consumable supply is authorized for use in additional print jobs; and other validation scenarios. If the validator 90 determines that the validation data is not validated, the controller 14 can be prevented from controlling the card printer 12, for example prevented from sending any print commands to the card printer 12. The controller 14 may also send a signal to the user interface device 16 indicating that the validation data has not been validated. If the validator 90 determines that the validation data is valid, the controller 14 can be permitted to control the card printer 12 to perform a print job, for example sending a print command to the card printer 12 to perform a print job. The controller 14 may also send a signal to the user interface device 16 indicating that the validation data has been validated. The controller 14 may continue to control the card printer 12 until a consumable supply event is detected.

With continued reference to FIG. 3, the controller 14 may also receive card data to be printed from the user interface device 16. The controller 14 may also retrieve data to be printed, for example personal data and/or non-personal data, from a data storage. The card data formatter 92 receives the data to be printed and formats the data into the appropriate format for the card. The print command generator 94 uses the formatted data generated by the formatter 92 to generate the print command that is sent to the card printer 12 to print a card. An example of a card data formatter and print command generator than can be used is the InstantID software available from Entrust Corporation of Shakopee, Minnesota.

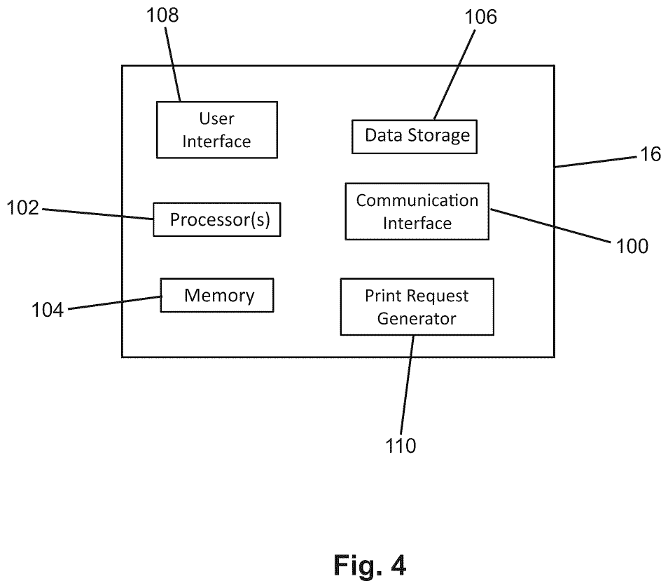

Referring to FIG. 4, an example of the user interface device 16 is illustrated. The user interface device 16 is depicted as including a communication interface 100, a processor(s) 102, memory 104, data storage 106, a user interface 108, and a print request generator 110. The user interface device 16 accesses the remote card printer controller 14 via, for example, a log-in process which must be successful before the device 16 can send a print request and data to be printed to the controller 14.

The communication interface 100 can be any type of communication interface that can permit the user interface device 16 to communicate with the controller 14 and optionally with the card printer 12. The communication interface 100 can be configured to permit communications via the internet. An optional additional communication interface (not illustrated) may also be provided to allow the user interface device 16 to communicate directly with the card printer 12. Communications to and from the user interface device 16 may be encrypted.

The processor(s) 102 may be one or more microprocessors, one or more GPUs and/or one or more CPUs that execute program instructions stored in the memory 104 for performing the functions of the user interface device 16. The data storage 106 may store data that is input by a user and store data received from the controller 14.

The user interface 108 may comprise one or more of a display screen which displays information to the user and/or one or more input devices such as buttons that allow a user to enter information. In an embodiment, the user interface 108 may be a touchscreen which both displays information and allows the user to enter information.

The print request generator 110 generates a print request that is sent to the controller 14. The print request can include an identification of the data to be printed on the card by the card printer 12 including, but not limited to, the name of the intended cardholder, address of the intended cardholder, a portrait photo of the intended cardholder, and other individual data of the intended cardholder. The print request may also include an identification of the type of card to be printed. In some embodiment, the print request may include a card account number although the card account number may also be obtained by the controller 14.

In an embodiment, the print request sent from the user interface device 16 may be incompatible with the consumable supply installed in the card printer 12, incompatible with the card printer 12 itself, or incompatible with some other aspect of the card printer 12. If the controller 14 receives such an incompatible print request, the controller 14 may send a message to the user interface device 16 indicating the incompatibility. In addition, if the controller 14 receives a print request from the user interface device 16 with no consumable supply installed in the card printer 12, the controller 14 may send a message to the user interface device 16 indicating that printing with the card printer 12 via the controller 14 is not available.

Examples of the user interface device 16 include, but are not limited to, a mobile phone, a tablet computer, a laptop computer, a personal computer, or a specially configured device.

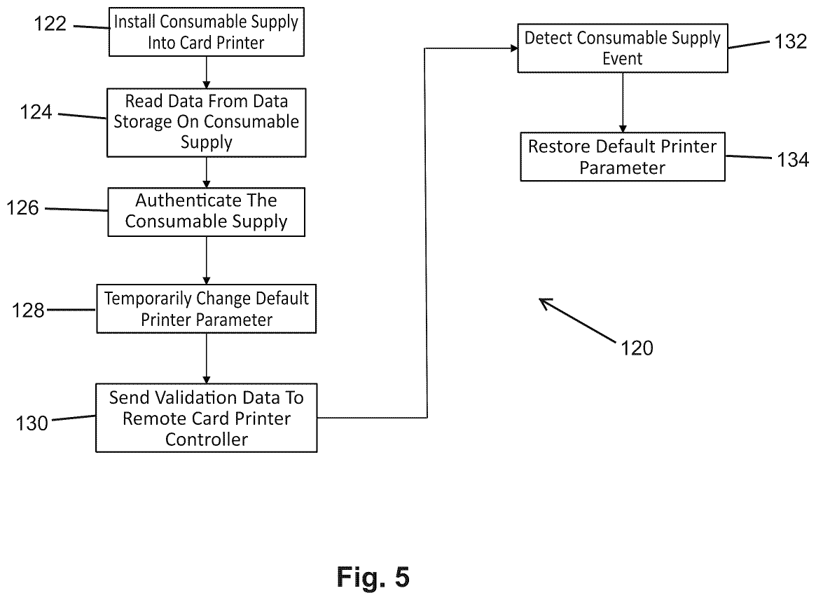

An example of a method 120 of temporarily changing a default printer parameter of the card printer 12 is illustrated in FIG. 5 and also referring to FIGS. 1-3. At operation 122, the consumable supply is installed into the card printer 12. Thereafter, at operation 124, data is read from the data storage device on the consumable supply. The card printer then authenticates the consumable supply at operation 126. Assuming the consumable supply is authenticated, the original default printer parameter is automatically changed at operation 128 to the second, temporary default printer parameter. If the consumable supply is not authenticated at operation 126, then operation 128 is not performed. At operation 130 the validation data is transmitted to the remote card printer controller 14. Operations 128 and 130 may occur sequentially one after the other in any order, or the operations 128, 130 may occur simultaneously. Moreover, operation 128 may occur prior to operation 126 based upon installation of the consumable supply into the card printer 12 and detection of the data storage device, without authenticating the consumable supply.

The method 120 may also include operation 132 where a consumable supply event, such as removal of the consumable supply from the card printer 12, or a determination is made that the consumable supply is spent, or a determination is made that an expiration date of the consumable supply or other predetermined date has been reached, a determination is made that the consumable supply has been used a predetermined number of times, or other consumable supply event, is detected. If a consumable supply event is detected, at operation 134, the original default printer parameter of the card printer 12 is automatically restored. The original default printer parameter of the card printer 12 may also be automatically restored based on the elapsing of a predetermined period of time after the change to the second, temporary default printer parameter.

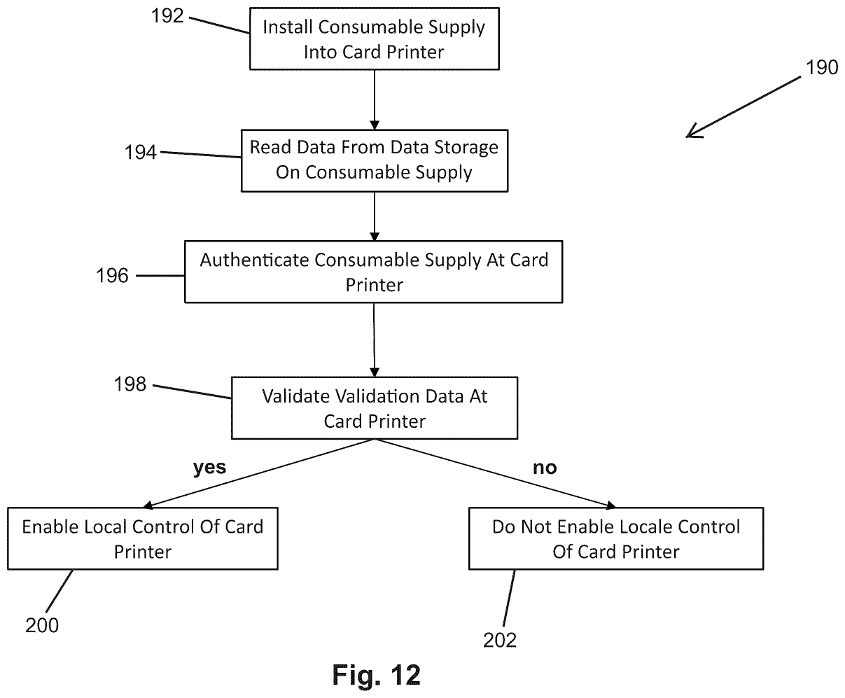

With reference to FIG. 12, along with FIGS. 1-2, a method 190 is illustrated where authentication of the consumable supply and validation of the validation data occur on the card printer (i.e. local authentication and validation) and local software controls the print jobs of the card printer (i.e. local software control). At operation 192, the consumable supply is installed into the card printer 12. Thereafter, at operation 194, data is read from the data storage device on the consumable supply. At operation(s) 196, the consumable supply is authenticated in the card printer 12, for example in the manner described herein. At operation 198, validation data is provided to the local controller of the card printer and the card printer validates the validation data. If the consumable supply is authenticated and the validation data is valid, local control of the card printer is enabled at operation 200. On the other hand, if the consumable supply is not validated and/or the validation data is not valid, local control of the card printer is not enabled at operation 202. The method 190 in FIG. 12 may also include an automatic temporary change in a default printer parameter to a second, printer parameter upon installation of the consumable supply and/or upon authentication of the consumable supply as described above, with an automatic reversion back to the default printer parameter upon detection of the consumable supply event.

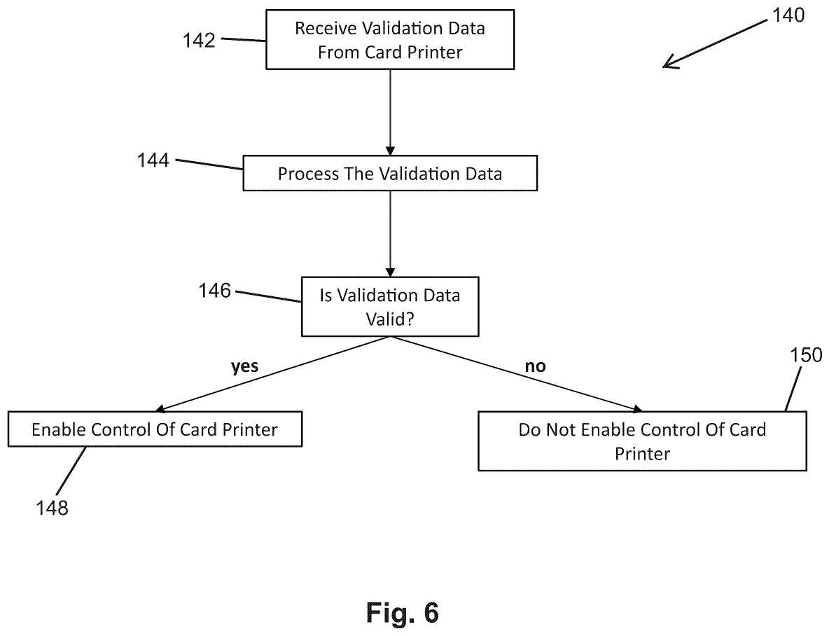

An example of a method 140 of validating the validation data received from the card printer 12 is illustrated in FIG. 6 and also referring to FIGS. 1-3. At operation 142, the remote card printer controller 14 receives the validation data from the card printer 12. At operation 144, the validation data is processed and at operation 146 a determination is made as to whether or not the validation data is valid. If the validation data is valid, at operation 148 the remote card printer controller 14 is enabled to control the card printer 12, for example by sending a print command to the card printer 12. Conversely, if the validation data is not determined to be valid, at operation 150 the remote card printer controller 14 is not enabled to control the card printer 12.

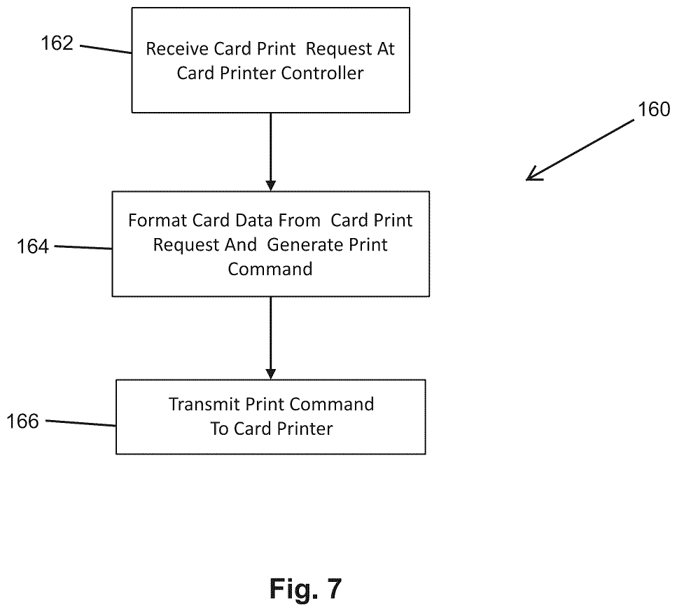

An example of a method 160 of generating a print command by the remote card printer controller 14 is illustrated in FIG. 7 and also referring to FIGS. 1 and 3-4. This example assumes that control of the card printer 12 by the controller 14 has been enabled. At operation 162, the remote card printer controller 14 receives a print request from the user interface device 16. At operation 164, the card data formatter 92 and the print command generator 94 of the controller 14 format the card data based on the print request and generates the print command. At operation 166, the print command is then transmitted from the controller 14 to the card printer 12.

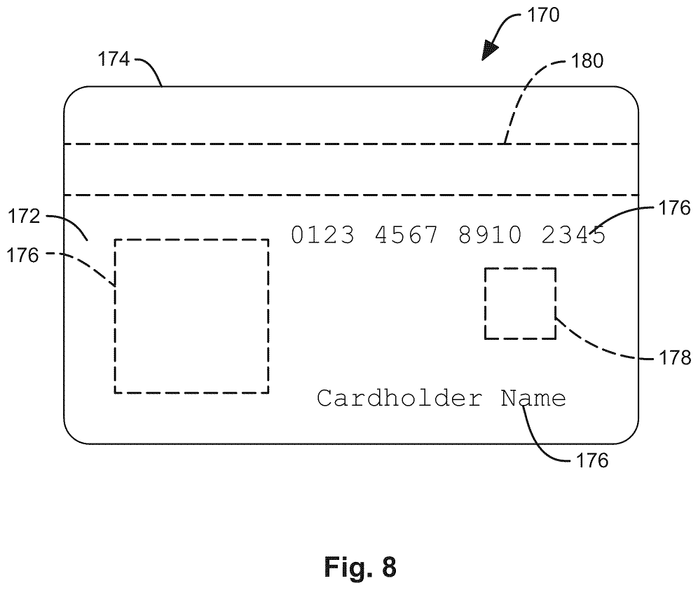

FIG. 8 illustrates an example of a card 170 as described herein. In this example, the card 170 is shown to include a front surface 172, a rear or back surface (not visible) opposite the front surface 172, and a perimeter edge 174 that defines the perimeter of the card 170. The card 170 includes various personal data 176, an optional integrated circuit chip 178 (contactless or contact), and an optional magnetic stripe 180 that is located on the card, for example on the rear surface. With continued reference to FIG. 8, the personal data 176 in this example can be a photograph of the intended card holder, a personal account number, a CVV number, and the name of the cardholder.

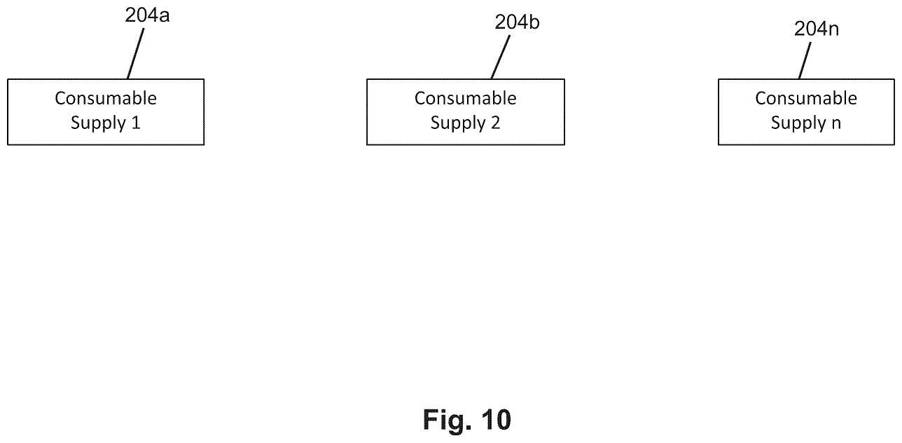

In an embodiment, different consumable supplies can be provided each having a different data storage having different stored data. For example, FIG. 10 illustrates different consumable supplies 204a, 204b . . . 204n. The consumable supplies 204a, 204b, 204n can be the same type of consumable supplies, for example all multi-color print ribbons, all monochromatic print ribbons, or different types of consumable supplies. Each consumable supply 204a, 204b, 204n includes a data storage device as described above. The data storage devices can have different data stored thereon that change different default printer parameters of the card printer, or that change the same default printer parameter in different ways. For example, installation of the consumable supply 204a could change the communication setting of the card printer as discussed above. Installation of the consumable supply 204b could change the communication setting of the card printer and also change a default transport speed of the card printer at which the card is transported within the card printer. Installation of a different consumable supply 204n could change any one or more of the default printer parameters described above with or without changing a communication setting.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A card printer control method, comprising:
receiving, at a remote card printer controller separate from a card printer, validation data from the card printer that results from electronically reading data that is stored on a consumable supply that is usable in the card printer;
the remote card printer controller processing the received validation data to determine if the received validation data is valid;
if the received validation data is determined to be valid, permitting the remote card printer controller to control operation of the card printer to print a card.

2. The card printer control method of claim 1, comprising automatically electronically reading the data that is stored on the consumable supply upon installing the consumable supply in the card printer, and transmitting the validation data to the remote card printer controller if the card printer authenticates the consumable supply.

3. The card printer control method of claim 1, comprising electronically reading the data from a data storage device on the consumable supply using an electronic reader in the card printer.

4. The card printer control method of claim 1, further comprising:
receiving, at the remote card printer controller, a print request from a user interface device;
the remote card printer controller processing the print request to generate at least one print command that is sent from the remote card printer controller to the card printer to print a card.

5. The card printer control method of claim 4, further comprising:
receiving, at the remote card printer controller, cardholder data to be printed onto the card from the user interface device.

6. The card printer control method of claim 2, further comprising preventing the remote card printer controller from controlling the card printer upon detection of a consumable supply event.

7. The card printer control method of claim 6, wherein the consumable supply event comprises removal of the consumable supply from the card printer, the consumable supply is spent, a predetermined date has been reached, or the consumable supply has been used a predetermined number of times.

8. A card printer control system, comprising:
a remote card printer controller separate from a card printer, the remote card printer controller is configured to:
receive validation data from the card printer that results from electronically reading data that is stored on a consumable supply that is usable in the card printer;
process the received validation data to determine if the received validation data is valid;
if the received validation data is determined to be valid, thereafter send at least one print command to the card printer to cause the card printer to print a card.

9. The card printer control system of claim 8, wherein the remote card printer controller is further configured to:
receive a print request from a user interface device;
process the print request to generate the at least one print command.

10. The card printer control system of claim 9, wherein the remote card printer controller is further configured to receive cardholder data to be printed onto the card from the user interface device.

11. The card printer control system of claim 8, wherein the remote card printer controller is in communication with the card printer via the internet.

12. A card printing system, comprising:
a card printer having a card input, a card output, a print station, a local card printer controller that controls operation of the card printer, and an electronic reader that is capable of electronically reading data stored on a consumable supply;
the card printer having at least one default printer parameter that is controllable by the local card printer controller;
a consumable supply that is installable in the card printer, the consumable supply including a data storage device with data stored thereon that is readable by the electronic reader;
the card printer is configured to read data from the data storage device and authenticate the consumable supply, and if the consumable supply is determined to be authentic automatically temporarily change the at least one default printer parameter to a second, temporary printer parameter, and when the card printer detects a consumable supply event automatically restore the at least one default printer parameter.

13. The card printing system of claim 12, wherein the at least one default printer parameter comprises software disabled, and the second, temporary printer parameter comprises software enabled.

14. The card printing system of claim 12, wherein the at least one default printer parameter and the second, temporary printer parameter are non-supply parameters that are not directly related to the consumable supply.

15. The card printing system of claim 12, wherein the consumable supply event comprises removal of the consumable supply from the card printer, the consumable supply is spent, a predetermined date has been reached, or the consumable supply has been used a predetermined number of times.

16. The card printing system of claim 12, wherein the print station comprises a direct to card thermal print station, and the consumable supply comprises a thermal print ribbon.

17. A card printing system, comprising:
a card printer having a card input, a card output, a print station, a local card printer controller that controls operation of the card printer, and an electronic reader that is capable of electronically reading data stored on a consumable supply;
the card printer having at least one default non-supply parameter that is controllable by the local card printer controller;
a consumable supply that is installable in the card printer, the consumable supply including a data storage device with data stored thereon that is readable by the electronic reader;
the card printer is configured to automatically temporarily change the at least one default non-supply parameter to a second, temporary non-supply parameter upon installation of the consumable supply in the card printer, and to restore the at least one default non-supply parameter upon detection of a consumable supply event.

18. The card printing system of claim 17, wherein the consumable supply event comprises removal of the consumable supply from the card printer, the consumable supply is spent, a predetermined date has been reached, or the consumable supply has been used a predetermined number of times.

19. The card printing system of claim 17, wherein the print station comprises a direct to card thermal print station, and the consumable supply comprises a thermal print ribbon.

20. The card printing system of claim 17, wherein the at least one default non-supply parameter comprises cloud-based software disabled, and the second, temporary non-supply parameter comprises cloud-based software enabled.
